(19) United States
(12) Patent Application Publication
(10) Pub. No.: US 2020/0001723 A1
(43) Pub. Date: Jan. 2, 2020

(54) Charging System for Submersible Autonomous Vehicle with Rechargeable Battery

(71) Applicant: AQUA PRODUCTS, INC., Cedar Grove, NJ (US)

(72) Inventors: Kameshwar Durvasula, Fair Lawn, NJ (US); Ethan Hanan, Teaneck, NJ (US)

(21) Appl. No.: 16/019,781

(22) Filed: Jun. 27, 2018

(51) Int. Cl. B60L 11/18; E04H 4/16; A47L 7/00

(52) U.S. Cl. CPC B60L 11/1816; E04H 4/1654; B60L 2230/10; A47L 2201/022; A47L 2201/04; A47L 7/0004

(57) ABSTRACT

A pool cleaning system includes a submersible autonomous vehicle and a charging station. The submersible autonomous vehicle is configured to perform cleaning operations in a pool and includes a rechargeable battery and a first motor. The first motor receives power from the rechargeable battery during the cleaning operations. The charging station is electrically coupled to a power source and includes a second motor. The second motor is configured to receive power from the power source. Additionally, the second motor is releasably, mechanically coupleable to the first motor of the submersible autonomous vehicle. The second motor operates the first motor so that the first motor generates electricity for recharging the rechargeable battery when the second motor is mechanically coupled to the first motor.

### FIELD OF INVENTION

The present invention relates to the field of autonomous vehicles and, in particular, to a charging system for a submersible, pool cleaning autonomous vehicle with a rechargeable battery.

### BACKGROUND

Autonomous vehicles are being introduced into an ever increasing number of facets of daily life in order to automate various tasks, such as cleaning a pool, cleaning an indoor space, and maintaining a lawn. Additionally or alternatively, autonomous vehicles (also referred to herein as robots) may be used for entertainment, law enforcement, and a wide range of other purposes. Regardless of the type of propulsion included in an autonomous vehicle, the propulsion system almost always includes a motor that utilizes power to create propulsion, whether by driving a pump impeller, a drive wheel assembly, etc.

Since autonomous pool cleaners mostly operate in water, it is particularly important to provide power to a pool cleaner's motor in a safe manner. Thus, pool cleaners often receive power via a tether or cable that provides an electrical connection between the pool cleaner and an external power source. However, in at least some instances, these tethers can kink, snag, catch (e.g., on features of a pool or furniture around a pool), or otherwise move undesirably. Additionally, tethers may limit the range of autonomous pool cleaner (or may become quite expensive to provide a desirable range). Consequently, in at least some scenarios, autonomous pool cleaners include rechargeable batteries that can supply electrical power to any motors included in the pool cleaner.

Obviously, rechargeable batteries are inherently limited by their battery life. Thus, even though battery life is constantly increasing with advances in battery technology, an autonomous pool cleaner with a rechargeable battery must be charged periodically. One of the simpler solutions for charging the rechargeable battery included in an autonomous pool cleaner is to remove the autonomous pool cleaner from a pool and connect the battery directly to a power source (e.g., plug the battery into an outlet or charger). Unfortunately, to effectuate this solution, the battery must have exposed leads that can create paths for battery discharge when the leads are exposed to impurities in a pool's water. Moreover, these leads may become corroded relatively quickly when exposed to impurities in a pool's water. Thus, the relatively simple solution of charging a battery via a battery source may, in reality, become quite complicated and require potentially complicated electrical and/or mechanical solutions to prevent discharge and/or corrosion.

Alternatively, in some instances, an autonomous pool cleaner may include a generator or other such charging-specific components, separate from the motor, and utilize fluid flow through the autonomous pool cleaner to operate the generator and charge the battery. However, this solution increases the cost of an autonomous pool cleaner (due to the added cost of added charging-specific components) and may also complicate the flow paths passing through the robot. Alternatively, the fluid flowing through the robot may be used to reverse a motor and convert the motor into a generator. Unfortunately, in these instances, when the motor is acting as a generator, the motor is unavailable to drive cleaning operations. Thus, the autonomous pool cleaner must remain in the pool for longer period of times which might expose the autonomous pool cleaner to additional and unnecessary wear.

In view of at least the aforementioned issues, a charging system for an autonomous pool cleaner with a rechargeable battery that can charge an autonomous pool cleaner without directly contacting the rechargeable battery is desired. Moreover, it may desirable to provide a charging system that can charge the autonomous pool cleaner when the autonomous pool cleaner is removed from the pool (i.e., without fluid flow).

### SUMMARY

The present invention relates to a pool cleaning system that can charge a battery-powered autonomous vehicle and, in particular, a battery-powered submersible autonomous vehicle. According to one embodiment, a pool cleaning system includes a submersible autonomous vehicle and a charging station (which may also be referred to herein interchangeably as a power source, power station, or a docking station). The submersible autonomous vehicle is configured to perform cleaning operations in a pool and includes a rechargeable battery and a first motor. The first motor receives power from the rechargeable battery during the cleaning operations. The charging station, which can be located in the pool or outside the pool (e.g., pool side) is electrically coupled to a power source and includes a second motor. The second motor is configured to receive power from the power source. Additionally, the second motor is releasably, mechanically coupleable to the first motor of the submersible autonomous vehicle. The second motor operates the first motor so that the first motor generates electricity for recharging the rechargeable battery when the second motor is mechanically coupled to the first motor. Thus, advantageously, the battery can be recharged by a component utilized during cleaning operations and the submersible autonomous vehicle need not include additional components dedicated to charging. Moreover, since the first and second motors are mechanically coupled to each other to drive the charging, the rechargeable battery need not include exposed leads.

In at least some of these embodiments, the charging station also includes a mechanical linkage that is coupled to the second motor and configured to releasably, mechanically couple the second motor to the first motor. Additionally or alternatively, the submersible autonomous vehicle may include a connector configured to mechanically connect with the mechanical linkage of the power source to mechanically couple the second motor to the first motor. In some of embodiments with a linkage and connector, the submersible autonomous vehicle also includes an internal linkage that mechanically connects the connector to the first motor. Any of these embodiments may ensure that the pool cleaner can be easily mechanically connected to the charging station in order to begin charging the rechargeable battery of the submersible autonomous vehicle. Moreover, in some embodiments, the charging station may include one or more sensors configured to detect when the submersible autonomous vehicle is proximate the charging station. These sensors may automate, or at least partially automate the charging process.

As some examples of linkages and connectors, the mechanical linkage may be a rotatable rod or shaft that rotates with the second motor and the connector may be an opening formed in a housing of the submersible autonomous vehicle that is configured to receive the rotatable rod or shaft. As another example, the connector may be an opening formed in a housing of the submersible autonomous vehicle and the mechanical linkage may be a laterally movable linkage configured to move into the opening when the submersible autonomous vehicle is proximate the charging station.

Still further, in some embodiments of the above pool cleaning system, the first motor comprises a pump motor that is configured to propel fluid through the submersible autonomous vehicle during the cleaning operations. Additionally or alternatively, the first motor may comprise a drive motor that is configured to drive a wheel assembly of the submersible autonomous vehicle during the cleaning operations. That is, the pool cleaning system may be compatible with a wide variety of pool cleaning robots, even if the pool cleaning robots only have one motor included therein (e.g., for a drive assembly or a pump system).

According to another embodiment, a charging station (i.e., a docking station, power station, or power source) for a battery-powered autonomous pool cleaner includes a power supply, a motor, and a mechanical linkage. The power supply is configured to receive power from an external power source. The motor is configured to receive power from the power supply. The mechanical linkage is coupled to the motor and is configured to be releasably, mechanically coupled to a pool cleaner motor included within an interior of the battery-powered autonomous pool cleaner in order to charge a rechargeable battery of the battery-powered autonomous pool cleaner.

In some of these embodiments, the charging station includes a memory and a processor. The memory may store motor control logic and the processor may be configured to operate the charging station's motor based on the motor control logic so that the motor rotates the pool cleaner motor when the linkage mechanically couples the motor to the pool cleaner motor. Among other advantages, this logic may ensure that the motor does not rotate the linkage before the linkage is connecting the motor to the pool cleaner motor.

Additionally or alternatively, the mechanical linkage may be a laterally movable linkage configured to move into an opening in the battery-powered autonomous pool cleaner when the battery-powered autonomous pool cleaner is proximate the charging station. In at least some of the embodiments, the memory may, in addition to or instead of the motor control logic, store linkage logic and the processor may be configured to operate the mechanical linkage (or more specifically, to operate an electro-mechanical element included in or associated with the mechanical linkage) based on the linkage logic so that the mechanical linkage moves into the opening. Still further, in some embodiments, the charging station may include one or more sensors that are connected to the processor and configured to determine when the pool cleaner is proximate the charging station, and the processor is configured to operate the mechanical linkage based on outputs of the one or more sensors. Consequently, the charging station may automatically, or at least partially automatically, connect to a pool cleaner to initiate recharging of a battery.

According to yet another embodiment, a submersible autonomous vehicle configured to perform cleaning operations in a pool includes a rechargeable battery and a motor. The motor operates in a motor mode to drive cleaning operations of the submersible autonomous vehicle when receiving power from the rechargeable battery and operates in a generator mode to charge the rechargeable battery when the submersible autonomous vehicle is mechanically coupled to a charging station. Consequently, the rechargeable battery need not include exposed leads and may be charged without adding any dedicated recharging components to the submersible autonomous vehicle.

In at least some of these embodiments, the submersible autonomous vehicle is mechanically coupled to a charging station when the submersible autonomous vehicle's motor is mechanically coupled to a motor included in the charging station. Moreover, in some of these embodiments, the motor comprises a pump motor that is configured to propel fluid through the pool cleaner during the cleaning operations and/or a drive motor that is configured to drive a wheel assembly of the submersible autonomous vehicle during the cleaning operations.

### BRIEF DESCRIPTION OF THE DRAWINGS

To complete the description and in order to provide for a better understanding of the present invention, a set of drawings is provided. The drawings form an integral part of the description and illustrate an embodiment of the present invention, which should not be interpreted as restricting the scope of the invention, but just as an example of how the invention can be carried out.

FIG. 1 is a perspective view of a system in accordance with an embodiment of the invention implemented in correspondence with a swimming pool.

FIG. 2 is a perspective view of a pool cleaner and charging station in accordance with an embodiment of the invention.

FIG. 3 schematically illustrates the pool cleaner of FIG. 2, in accordance with an embodiment of the invention.

FIG. 4 schematically illustrates the charging station of FIG. 2, in accordance with an embodiment of the invention.

FIG. 5 schematically illustrates a coupling formed between the pool cleaner and the charging station shown in FIG. 2 that effectuates charging of a battery included in the pool cleaner in accordance with an embodiment of the invention.

Like numerals identify like components throughout the figures.

### DETAILED DESCRIPTION

The following description is not to be taken in a limiting sense but is given solely for the purpose of describing the broad principles of the invention. Embodiments of the invention will be described by way of example, with reference to the above-mentioned drawings showing elements and results according to the present invention.

Generally, the charging system presented provides a charging station (also referred to herein as a power source, power station, docking station, etc.) that can mechanically connect to a pool cleaner. This mechanical connection allows a motor included in the charging station to drive a motor included in the pool cleaner, thereby causing the pool cleaner's motor to act as a generator. That is, the pool cleaner presented herein includes a motor that can operate in a motor mode or a generator mode and the charging station includes a motor that, when mechanically linked to the pool cleaner's motor, shifts the pool cleaner's motor to the generator mode.

Since the pool cleaner's battery is charged when the pool cleaner is mechanically connected to the charging station (as opposed to electrically connected to the charging station), the battery need not include any exposed leads and can be substantially sealed (except for a connection to the pool cleaner's motor). That is, the battery may be enclosed with a motor and controller. Moreover, in most embodiments, the charging station is disposed outside of the pool and the pool cleaner moves or is moved adjacent to the charging station so that a mechanical connection can be formed between the pool cleaner and the charging station. That is, the pool cleaner need not utilize fluid flow to charge the battery. Consequently, the pool cleaner need not remain in the pool during charging (which might be dangerous). That being said, in some embodiments, the charging station could also be disposed in the pool.

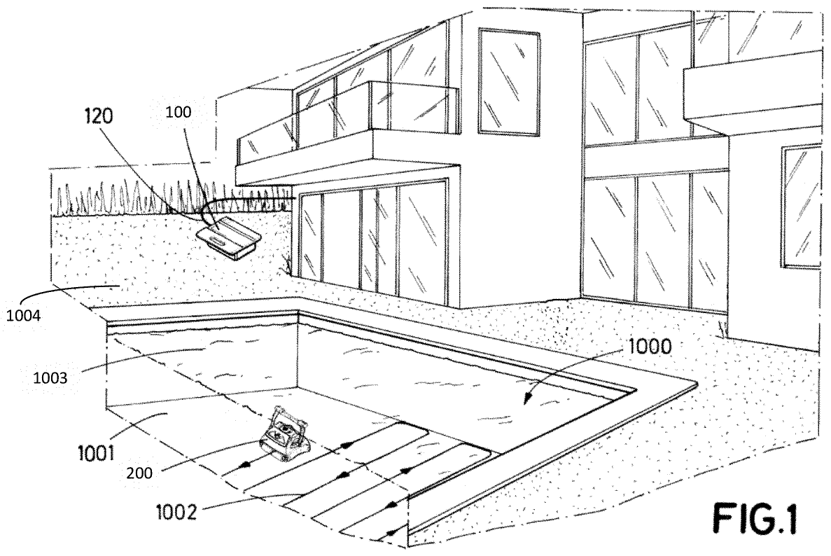

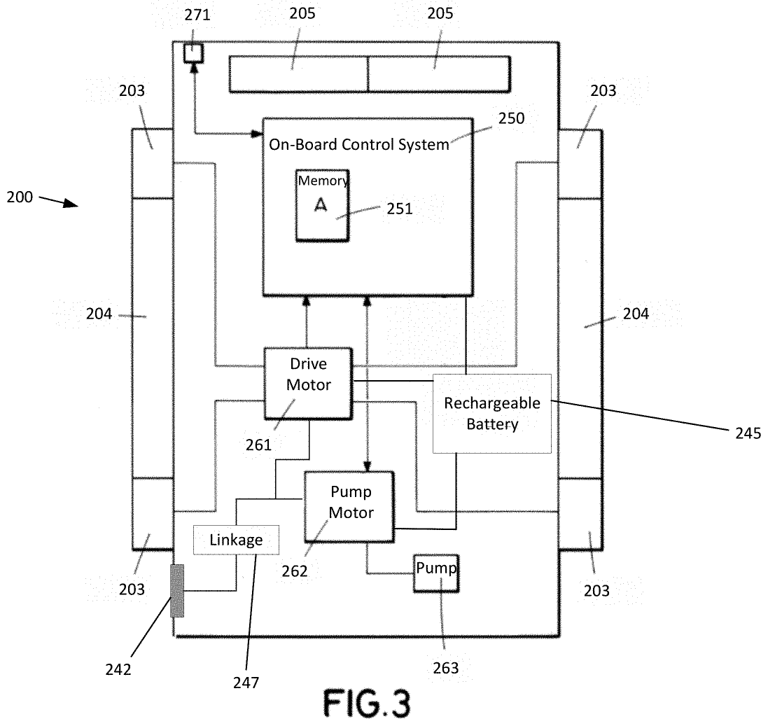

Now turning to FIG. 1, in this Figure, a pool cleaner 200 is illustrated moving on the bottom surface 1001 of a swimming pool 1000, following a path 1002. The pool cleaner 200 includes a rechargeable battery (which is described below in connection with FIG. 3) and, thus, need not receive electrical power via a power cable. Instead, the pool cleaner 200 can be periodically connected to the power source 100 (which may also be referred to as docking station 100, charging station 100, etc.) to charge the rechargeable battery. That is, the pool cleaner 200 can drive out of the pool 1000 on its own or be removed from the pool 1000 and then the pool cleaner 200 can move or be moved proximate the power source 100 for recharging. If the pool cleaner 200 exits the pools autonomously (e.g., if the pool cleaner 200 drives out of the pool) the pool cleaner 200 may exit in accordance with any techniques now known or developed hereafter.

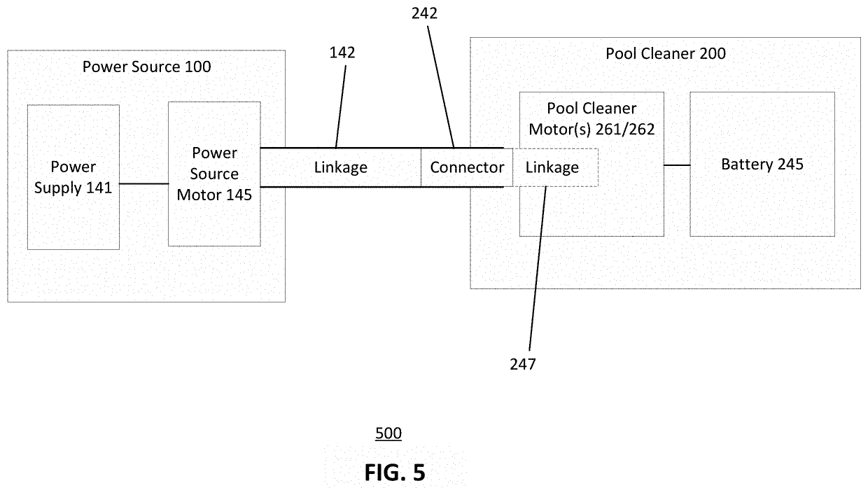

As an example, in some embodiments, the pool cleaner 200 can drive up a wall 1003, out of the pool 1000 and drive into connection with (e.g., dock in/on) the power source 100. Alternatively, a user can remove the pool cleaner 200 from the pool 1000 and either place the pool cleaner 200 in connection with the power source 100 or remove the pool cleaner 200 from the pool 1000 and place the pool cleaner 200 on the pool deck 1004 to allow the pool cleaner 200 to move into connection with) the power source 100. As is described below in connection with FIG. 5, when the pool cleaner 200 is connected to the power source 100, a motor in the power source 100 is coupled to a motor included in the pool cleaner 200 and spins the motor in the pool cleaner 200 so as to cause the pool cleaner's motor to act as a generator and charge the battery in the pool cleaner 200.

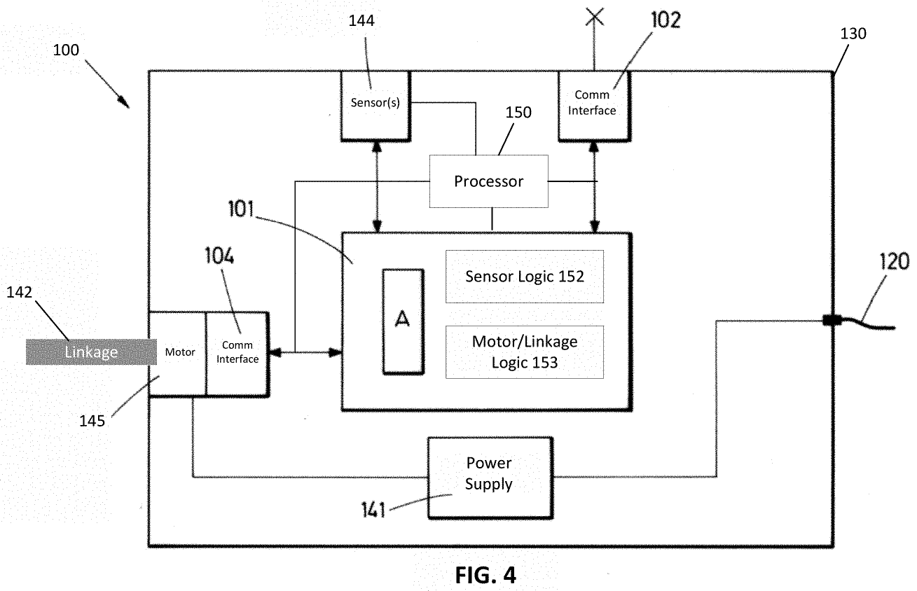

The power source 100 is, in this embodiment, a pool side power source that is placed a distance (in at least some countries, 10 feet is the regulatory minimum) from the edge of the swimming pool 1000, and that is connected to an external power grid via a cable 120. In at least some embodiments, the power source 100 may include a communication module or means for wireless communication with a user terminal, such as smartphone or tablet computer, so that a user can monitor power consumption and/or communicate with the power source 100 and/or the pool cleaner 300 (e.g., via the power source 100), as is described below in connection with FIG. 4.

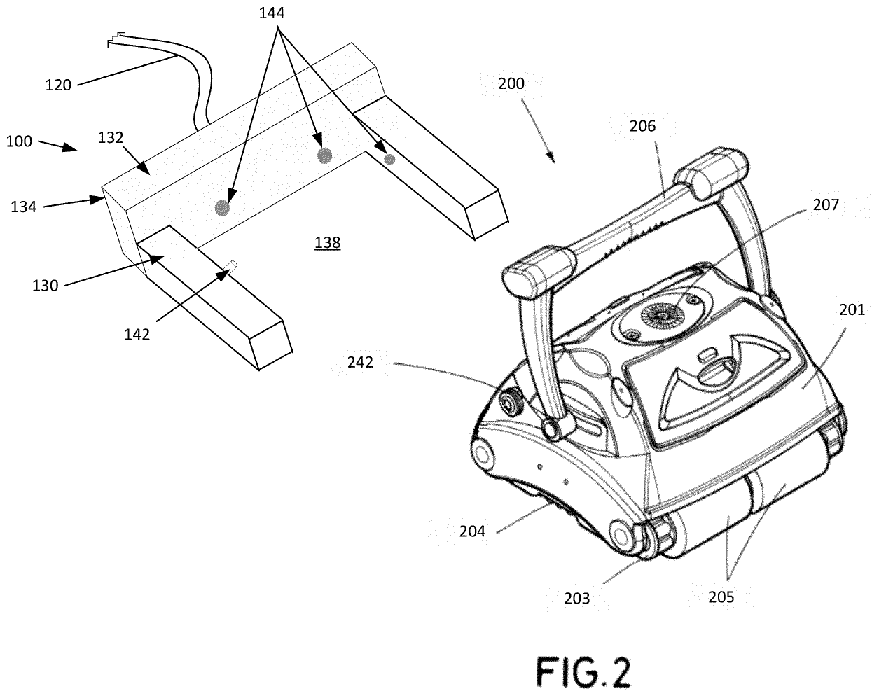

FIG. 2 shows how, in an example embodiment, the power source 100 comprises a housing 130 with a back portion 132 and arms 134 that extend outwards from the back portion 132. The back portion 132 and arms 134 may define at least one internal compartment/cavity that can house electrical and mechanical components, such as electrical components configured to convert electricity (e.g., alternating current (AC)power) received from power cable 120 to electricity (e.g., low voltage direct current (DC) power) suitable for a pool cleaner 200 and/or electrical and mechanical components configured to form a mechanical connection between the power source and the pool cleaner. For example, the power source 100 may include a linkage 142 that connects a motor included in the power source 100 to a motor included in the pool cleaner 200, as is described in further detail below. In the depicted embodiment, the linkage 142 may be a rotatable rod or shaft that rotates with a motor included in the power source 100; however, in other embodiments, the linkage 142 may comprise any mechanical component or combination of mechanical components suitable for mechanically coupling two motors to each other (so that rotational motion of one motor is imparted to the other motor).

When the pool cleaner 200 is docked in the power source 100, the pool cleaner may be disposed in a well 138 defined between the arms 134. In at least some embodiments, the power source 100 may include sensors 144, such as proximity sensors, that can detect the presence of the pool cleaner 200 in the well 138. Then, when a pool cleaner 200 is detected in the well 138, the power source 100 may extend the linkage 142 so that the linkage connects to the pool cleaner 100. That is, the linkage 142 may be a movable linkage that can move into engagement with the pool cleaner 200 (e.g., by moving into an aperture or opening included on an external housing of the pool cleaner 200). However, in various embodiments, the sensors 144 and linkage 142 need not be disposed in the positions shown in FIG. 2. Instead, one or more linkages 142 could be disposed in one or more of the locations where sensors 144 are shown in FIG. 2 or in any other location adjacent the well 138. Similarly, sensors 144 could include one or more sensors 144 disposed in any location that allows the sensors 144 to detect the presence of a pool cleaner 200 in well 138.

Still further, in other embodiments, the power source 100 need not include a well 138 and the power source 100 may or may not be able to detect when the pool cleaner 200 is adjacent the power source 100 and/or coupled to the linkage 142. For example, the housing 130 of the power source 100 might include only a back portion 132, without any sensors 144, and the linkage 142 may extend forwardly 142 from the back portion 132 so that a pool cleaner 200 can drive forwardly into engagement with the linkage 142. Additionally, as mentioned, the linkage 142 need not be a rotatable rod or shaft and may comprise any components that can mechanically couple a motor included in the power source to a motor included in the pool cleaner 200 (as is shown in FIG. 5).

Still referring to FIG. 2, this Figure also illustrates how, in an example embodiment, the pool cleaner 200 may comprise a housing 201 that generally defines an exterior of the pool cleaner 200, drive wheels 203 and track 204 for moving pool cleaner 200 (the drive wheels 203 and track 204 may be one example of a drive assembly), a brush 205 for uses known in the art, a handle 206 for uses known in the art, and a pump outlet 207 for a pump unit. Water is typically sucked in through inlets arranged in correspondence with the bottom of the housing 201 of pool cleaner 200, so that it passes through at least one filter wall of a filter assembly arranged within the pool cleaner 200, before exiting through the outlet 207, so that debris is retained within the pool cleaner 200, by the filter. However, in other embodiments, the pool cleaner 200 may include any desirable features, including or excluding any combination(s) of features illustrated in FIG. 2. For example, in other embodiments, the pool cleaner 200 may be driven by fluid propulsion instead of wheel assemblies.

Additionally, and importantly, the pool cleaner 200 includes a connection point 242 (also referred to as connector 242) that can connect with the linkage 142 of the power source 100. In the depicted embodiment, the connection point 242 is an opening or receptacle that provides access into the housing 201 (or at least access into a water sealed compartment) and is included on a back, left portion of housing 201. However, in other embodiments, the connection point 242 may be embodied as any structural element and may be included on any portion of housing 201, provided that the connection point 242 can be periodically removably mechanically coupled to the linkage 142 included on the power source 100.

FIG. 3 schematically illustrates electronics included on-board of the pool cleaner 200, according to an example embodiment. As mentioned, the pool cleaner 200 includes a rechargeable battery 245. Additionally, the pool cleaner 200 may include an on-board control system 250 configured to control operations of the pool cleaner 200, a drive motor 261 for driving the wheels 203 and track 204 (and, in some embodiments, also the brush 204), and a pump motor 262 for driving the pump 263. However, in other embodiments, one and the same motor is used for driving both pump 263 and the wheels 203 add tracks 204 (and/or other means for propelling/displacing the robot). In still other embodiments, the pool cleaner need not include a drive motor 261 and drive assembly (wheels 203 and tracks 204) and may be a fluid-propelled pool cleaner.

The battery 245 may be operably connected to any combination of the controller 250, the drive motor 261, and the pump motor 262. Moreover, any of the motors included in the pool cleaner (e.g., drive motor 261 and/or pump motor 262) may be mechanically coupled to the connection point 242. In the depicted embodiment, drive motor 261 and pump motor 262 are both shown mechanically coupled to the connection point 242 via a linkage 247; however, in other embodiments, one or both of these motors may be mechanically coupled to the connection point 242. For example, if the pool cleaner only includes a pump motor, only the pump motor will be coupled to the connector 242 (this example aside, pool cleaners with two motors may also have only one motor connector to the connector 242). Moreover, any motor(s) coupled to the connector 242 need not be coupled via linkage 247 and, instead, can be coupled directly thereto. For example, one motor may be coupled to the connector 242 via linkage 247 and another motor may be directly coupled to connector 242.

In the depicted embodiment, the on-board control system 250 is operatively connected to the drive motor 261 and the pump motor 262 so that the on-board control system 250 can interact with these components of the pool cleaner 200 to operate the pool cleaner in accordance with a setup of the on-board control system 250. In FIG. 3, the setup is illustrated by a set of setup data “A” loaded in a memory 251 of the on-board control system 250. Thus, in the depicted embodiment, the on-board control system 250 operates the motors 261 and 262 in accordance with the software “A” loaded in the on-board control system.

Still referring to FIG. 3, in the illustrated embodiment, the pool cleaner 200 also includes one or more sensors 271. The one or more sensors 271 may include a tilt sensor and/or a proximity sensor, and are connected to the on-board control system 250 to allow the on-board control system to read sensor data from the sensors. The on-board control system 250 may respond to output from the sensors 271, for example, by operating one or both motors 261 and 262, and/or by operating one or both tracks 204, depending on the setup of the on-board control system 250. For example, motors 261 and 262 may operate to cause the pool cleaner 200 to drive into the well 138 of the power source 100 and/or to effectuate a connection between the linkage 142 included in the power source and the connection point 242 included on the pool cleaner 200.

Now turning to FIG. 4, this Figure schematically illustrates the layout of power source 100 in accordance with an embodiment of the invention. That is, FIG. 4 illustrates electrical and mechanical components that are disposed at least partially within the housing 130 of the power source 100. The power source 100 is connectable to an electrical network (not shown, but typically the general power supply grid) via cable 120. In particular, the cable 120 connects the electrical network to internal power supply 141 of the power source 100. The power supply 141, in turn, is connected to a motor 145 (also referred to herein as power source motor 145). Consequently, the motor 145 may be powered by electrical power received from a power grid via cable 120.

The motor 145 is connected to or connectable to the linkage 142 and, since the linkage 142 can mate with one or more motors included in the pool cleaner 200 (which may generally referred to as “pool cleaner motors”) via connector 242, motor 145 can be coupled to one or more pool cleaner motors included in the pool cleaner 200. In some embodiments, the linkage 142 may be movable with respect to the power source motor 145 so that the linkage can selectively extend out of housing 130 to selectively engage the connector 242 included on the pool cleaner 200. For example, in FIG. 4, the linkage may move laterally (e.g., side to side when FIG. 4 is viewed in landscape) with respect to motor 145 so that the linkage 142 can selectively move outwards from the motor 145 to engage a connector 242 included on a pool cleaner 200. That being said, in other embodiments, the linkage 142 may be fixed with respect to the motor 145. For example, the linkage 142 may be a fixed rotatable rod/shaft and the pool cleaner 200 may move or be moved so that the connector 242 mates with the fixed rotatable rod/shaft (e.g., so that the rotatable shaft slides into the connector 242).

Still referring to FIG. 4, in addition to the aforementioned components, the power source 100 may also include a memory 101, a communications interface 102, sensors 144, and a processor 150. The memory 101 may store one or more sets of setup data, such as setup data A, that can include operational logic to control operations of a pool cleaner 200 and that can be transferred to the pool cleaner 200 (e.g., via a wireless connection or wires included in linkage 142). Memory 101 may also store motor/linkage logic 153 that can be executed by processor 150 to control operations of motor 145 and/or the linkage 142. Still further, memory 101 may store sensor logic 152 that is executable by the processor 150 to operate and/or respond to outputs of sensors 144. Alternatively, in some instances, the motor/linkage logic 153 may cause the processor 150 to respond to outputs generated by the sensors 144. For example, the processor 150 may respond to outputs generated by sensors 144 by modifying the motor/linkage logic 153.

The communication interface 102 may enable wireless communication (for example, adapted for communication according to a protocol such as Wi-Fi or Bluetooth) and/or wired communication (e.g., communications module 102 may include a USB port). This may allow the power source 100 to communicate with a user terminal, such as a personal computer, tablet, smartphone, etc. to update operational instructions/logic for the pool cleaner 200, the motor 145, the linkage 142, and/or the sensors 144 (e.g., to update motor/linkage logic 153). By comparison, the memory 101 may be coupled to the linkage 142 and/or the motor 145 via a communication interface 104.

For example, a user may send updates to the power source 100 that specify operational parameters to be used when operating motor 145 when the power source 100 is recharging a particular rechargeable battery included in a particular pool cleaner. Additionally or alternatively, a user may send updates to the power source to specify the manner in which the pool cleaner 200 should operate (e.g., the user may send setup data B to be stored in addition to or in lieu of setup data A). If the power source 100 receives operational instructions for the pool cleaner (e.g., if power source 100 receives setup data B), the instructions may be forwarded to the pool cleaner 200 (e.g., via a wireless connection) or stored in the memory 101 of the power source 100.

The sensors 144 may be any type of sensors, such as proximity sensors that might be able to detect the presence of a pool cleaner 200 in a well 138 (see FIG. 2). The processor 150 can operate the sensors 144 based on instructions stored in the memory 101 (e.g., sensor logic 152) and, in at least some embodiments, can operate (e.g., move) the linkage 142 and/or operate (e.g., run) the motor 145 based on data from sensors 144 (e.g., motor/linkage logic 153 may be dependent on feedback from sensors 144). For example, in at least some embodiments, the sensors 144 may sense the presence of a pool cleaner 200 on, in, or adjacent the power source 100 and then, based on motor/linkage logic 153, the processor 150 may actuate the linkage 142 to engage the pool cleaner 200 (via connector 242). Moreover, when the linkage 142 is connected to connector 242, the processor 150 may run the motor 245 (based on motor/linkage logic 153) to initiate charging of the rechargeable battery 245 included in the pool cleaner 200, as is described in further detail below.

Now turning to FIG. 5 for a description of a block diagram illustrating the connection 500 formed between a pool cleaner 200 and a power source 100 when the pool cleaner 200 is docked in, parked adjacent to, mated with, or otherwise connected to the power source 100. As can be seen, the connection 500 is formed between the linkage 142 of the power source 100 and the connector 242 of the pool cleaner 200. As mentioned, this connection 500 can be formed when the pool cleaner 200 moves into engagement with the power source 100 (e.g., when the docks on the power source 130) or when a user manually connects the pool cleaner 200 to the power source 130 (e.g., by inserting or plugging linkage 142 into connector 242).

The connection 500 (e.g., the connection between linkage 142 and connector 242) provides a mechanical coupling between the pool cleaner 200 and the power source 100 so that the motor 145 included in the power source 100 is mechanically linked to the at least one motor included in the pool cleaner 200, such as drive motor 261 and/or pump motor 262. Consequently, this mechanical connection may be able to convert at least one motor included in the pool cleaner 200 into a generator. For example, during pool cleaning operations, pump motor 262 may consume energy and function in a first/motor mode to propel fluid through the pool cleaner (e.g., by driving a pump impeller). Then, when the pool cleaner 200 is connected to the power source via connection 500, the power source motor 145 may drive the pump motor 262 to cause the pump motor to operate in a second/generator mode and generate energy. In some embodiments, a pool cleaner motor may rotate in a first rotational direction when operating in motor mode and rotate in a second rotational direction, opposite the first, when operating in the generator mode. Alternatively the motor may rotate in the same direction both modes.

More specifically, the power source motor 145 may be driven by power supplied to the motor 145 by the power supply 141. For example, the power supply 141 may deliver approximately 24 volts of electricity to the motor 145 at approximately 1.5 amps to cause the motor 145 to rotate at a particular rotational speed. The linkage 142 and connector 242 couple one or more pool cleaner motors (e.g., motor 261 and/or 262) to the power source motor 145 (either directly or via an optional linkage 247 extending between the connector 242 and the one or more pool cleaner motors) and cause the one or more pool cleaner motors (e.g., motor 261 and/or 262) to rotate at substantially the same speed as the power source motor 145. The rotational movement of the one or more pool cleaner motors (e.g., motor 261 and/or 262) is then converted into electrical power in any manner now known or developed hereafter and, thus, can charge the rechargeable battery 245. Referring back to the example provided above, if the power supply 141 delivers 24 volts of electricity to the motor 145 at 1.5 amps to motor 145, the rotation of the one or more pool cleaner motors (e.g., motor 261 and/or 262) may generate approximately 7.2 volts of power at approximately 1 amp.

In view of the foregoing, the battery 245 need not include any exposed electrical leads that might corrode or cause the battery to discharge when the pool cleaner is under water. Instead, the pool cleaner 200 simply includes a connection point (e.g., connector 242) that allows one or more motors included in the pool cleaner 200 to be mechanically linked to one or more motors included in the power source 100. That being said, in some embodiments, the connection 500 may also provide a data transfer connection between the power source 100 and the pool cleaner 200 (e.g., so that the power source 100 can transfer setup data to the pool cleaner 200). For example, connection 500 may effectuate a radio- frequency identification (RFID) connection, near field communication (NFC) wireless connection, an optical link, etc. However, this data transfer connection is provided in addition to the mechanical connection, not in lieu of the mechanical connection.

Moreover, due to the foregoing features, in at least some embodiments, the pool cleaner 200 can perform cleaning operations and charging operations with a single motor. For example, a battery-driven pool cleaner may operate with fluid propulsion driven by a pump motor. Then, to recharge the battery the pump motor is mechanically coupled to the power source (e.g., via linkage 142, connector 242, and, optionally, linkage 247) and driven by the power source motor 145 to generate rotational energy that can be converted to electrical energy to recharge battery 245.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

It is also to be understood that the drive module described herein, or portions thereof may be fabricated from any suitable material or combination of materials, such as plastic, foamed plastic, wood, cardboard, pressed paper, metal, supple natural or synthetic materials including, but not limited to, cotton, elastomers, polyester, plastic, rubber, derivatives thereof, and combinations thereof. Suitable plastics may include high-density polyethylene (HDPE), low-density polyethylene (LDPE), polystyrene, acrylonitrile butadiene styrene (ABS), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof.

Finally, it is intended that the present invention cover the modifications and variations of this invention that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the invention.

Similarly, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

1. A pool cleaning system comprising:
a submersible autonomous vehicle configured to perform cleaning operations in a pool, the submersible autonomous vehicle including:
a rechargeable battery; and
a first motor that receives power from the rechargeable battery during the cleaning operations; and
a charging station that is electrically coupled to a power source, the charging station including a second motor that is:
configured to receive power from the power source; and
releasably, mechanically coupleable to the first motor of the submersible autonomous vehicle, wherein the second motor operates the first motor so that the first motor generates electricity for recharging the rechargeable battery when the second motor is mechanically coupled to the first motor.

2. The pool cleaning system of claim 1, wherein the charging station further comprises:
a mechanical linkage that is coupled to the second motor and configured to releasably, mechanically couple the second motor to the first motor.

3. The pool cleaning system of claim 2, wherein the submersible autonomous vehicle further comprises:
a connector configured to mechanically connect with the mechanical linkage of the power source to mechanically couple the second motor to the first motor.

4. The pool cleaning system of claim 3, wherein the mechanical linkage is a rotatable rod or shaft that is rotated by the second motor and the connector is an opening formed in a housing of the submersible autonomous vehicle that is configured to receive the rotatable rod or shaft.

5. The pool cleaning system of claim 3, wherein the connector is an opening formed in a housing of the submersible autonomous vehicle and the mechanical linkage is a laterally movable linkage configured to move into the opening when the submersible autonomous vehicle is proximate the charging station.

6. The pool cleaning system of claim 5, wherein the charging station further comprises:
one or more sensors configured to detect when the submersible autonomous vehicle is proximate the charging station.

7. The pool cleaning system of claim 3, wherein the submersible autonomous vehicle further comprises:
an internal linkage that mechanically connects the connector to the first motor.

8. The pool cleaning system of claim 1, wherein the first motor is a pump motor that is configured to propel fluid through the submersible autonomous vehicle during the cleaning operations.

9. The pool cleaning system of claim 1, wherein the first motor is a drive motor that is configured to drive a wheel assembly of the submersible autonomous vehicle during the cleaning operations.

10. The pool cleaning system of claim 1, wherein the rechargeable battery does not have exposed electrical leads configured to connect to a power source.

11. A charging station for a battery-powered autonomous pool cleaner, comprising:
a motor that is configured to receive power from an external power source; and
a mechanical linkage that is coupled to the motor and that is configured to be releasably, mechanically coupled to a pool cleaner motor included within an interior of the battery-powered autonomous pool cleaner in order to charge a rechargeable battery of the battery-powered autonomous pool cleaner.

12. The charging station of claim 11, wherein the mechanical linkage is a rotatable shaft that is rotated by the motor.

13. The charging station of claim 12, further comprising:
a memory storing motor control logic;
a processor configured to operate the motor based on the motor control logic so that the motor rotates the pool cleaner motor when the linkage mechanically couples the motor to the pool cleaner motor.

14. The charging station of claim 11, wherein the mechanical linkage is a laterally movable linkage configured to move into an opening in the battery-powered autonomous pool cleaner when the battery-powered autonomous pool cleaner is proximate the charging station.

15. The charging station of claim 14, further comprising:
a memory storing linkage logic; and
a processor configured to operate an electro-mechanical element included in or associated with the mechanical linkage based on the linkage logic so that the mechanical linkage moves into the opening.

16. The charging station of claim 15, further comprising:
one or more sensors configured to determine when the pool cleaner is proximate the charging station, wherein the processor is configured to operate the mechanical linkage based on outputs of the one or more sensors.

17. A submersible autonomous vehicle configured to perform cleaning operations in a pool, comprising:
a rechargeable battery; and
a motor that operates in a motor mode to drive cleaning operations of the submersible autonomous vehicle when receiving power from the rechargeable battery and that operates in a generator mode to charge the rechargeable battery when the submersible autonomous vehicle is mechanically coupled to a charging station.

18. The submersible autonomous vehicle of claim 17, wherein the submersible autonomous vehicle is mechanically coupled to a charging station when the motor is mechanically coupled to a motor included in the charging station.

19. The submersible autonomous vehicle of claim 17, wherein the motor comprises at least one of:
a pump motor that is configured to propel fluid through the pool cleaner during the cleaning operations; and
a drive motor that is configured to drive a wheel assembly of the submersible autonomous vehicle during the cleaning operations.

20. The submersible autonomous vehicle of claim 17, wherein the rechargeable battery does not have exposed electrical leads configured to connect to a power source.

21. The pool cleaning system of claim 1, wherein the charging station comprises:
a. a housing comprising (i) a back portion and (ii) first and second arms extending outward from the back portion, the first and second arms defining a well configured to receive the submersible autonomous vehicle;
b. a cable electrically connecting the housing to an external power grid; and
c. a rotatable rod or shaft protruding from either the first arm or the second arm.
